(19) United States
(12) Patent Application Publication
(10) Pub. No.: US 2026/0078671 A1
(43) Pub. Date: Mar. 19, 2026

(54) TRANSMISSION TOMOGRAPHY FOR STRUCTURE AND MINEROLOGY OF SOLIDS IN PROJECTILE MOTION

(71) Applicant: Schlumberger Technology Corporation, Sugar Land, TX (US)

(72) Inventor: Can Evren Yarman, Paris (FR)

(21) Appl. No.: 18/884,299

(22) Filed: Sep. 13, 2024

(51) Int. Cl. E21B 49/00; E21B 21/06; E21B 44/00; G01N 23/02; G01N 23/046; G06T 7/20

(52) U.S. Cl. CPC E21B 49/005; E21B 21/065; G01N 23/025; G01N 23/046; G06T 7/20; G01N 2223/616; G06T 2207/30181

(57) ABSTRACT

A system is provided that includes an imaging system used to obtain images of one or more solids extracted from a reservoir during a projectile motion of the one or more solids, a processing circuitry, and a memory, accessible by the processing circuitry, the memory storing instructions that, when executed by the processing circuitry cause the processing circuitry to perform operations. The operations include controlling the imaging system to obtain the images of the one or more solids during the projectile motion and obtaining one or more physical properties of the one or more solids based on the images of the one or more solids during the projectile motion.

### BACKGROUND

The present disclosure generally relates to systems and methods for measuring structural properties of solids extracted from geological reservoirs. More specifically, the present disclosure is directed to performing image reconstruction of solids in projectile motion.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Characterization of environments via analysis of solids (e.g., rock particles) has been widely used in industry and scientific applications, including, but not limited to, space exploration, mining, civil engineering, geothermal, and oil and gas. Image data of the solids typically come from imaging systems that produce digital images or three-dimensional (3D) images from a laser scanner. Once solids are detected and segmented, they may be used to compute the properties such as size, shapes, textures, morphology, structure, petrophysical properties, and the like.

In oil and gas, geothermal, as well as scientific exploration applications, solids are produced during drilling activities. The solids are called cuttings or carvings, depending on their sizes. Solids are generally used to identify lithology types for use in subsurface characterization and are one of the highest available and lowest cost data sources for understanding and characterizing the subsurface properties. As such, there is a need to characterize solids early in the drilling process to provide accurate and near real-time reconstruction of the subsurface properties (e.g., reservoir characteristics).

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a system is provided that includes an imaging system used to obtain images of one or more solids extracted from a reservoir during a projectile motion of the one or more solids, a processing circuitry, and a memory, accessible by the processing circuitry, the memory storing instructions that, when executed by the processing circuitry cause the processing circuitry to perform operations. The operations include controlling the imaging system to obtain the images of the one or more solids during the projectile motion and obtaining one or more physical properties of the one or more solids based on the images of the one or more solids during the projectile motion.

In certain embodiments, a method includes controlling, via processing circuitry, an imaging system to obtain images of one or more solids extracted from a reservoir during a projectile motion of the one or more solids and obtaining, via the processing circuitry, one or more physical properties of the one or more solids based on the images of the one or more solids during the projectile motion.

In certain embodiments, a non-transitory, computer-readable storage medium, including processor-executable routines that, when executed by a processor, cause the processor to perform operations including controlling an imaging system to obtain images of one or more solids extracted from a reservoir during a projectile motion of the one or more solids and obtaining one or more physical properties of the one or more solids based on the images of the one or more solids during the projectile motion.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram illustrating a drilling system including an imaging system and an analysis system, in accordance with an embodiment of the present disclosure;

FIG. 2 is a schematic diagram illustrating a shale shaker removing solids from drilling fluid including the analysis system of FIG. 1, in accordance with an embodiment of the present disclosure;

FIG. 3 is a schematic embodiment of a drill bit generating solids, in accordance with aspects of the present disclosure;

FIG. 4 is a schematic diagram illustrating a drilling system including the tomography system and solids in projectile motion, in accordance with aspects of the present disclosure;

FIG. 5 an exploded view of solids in projectile motion and the tomography system of FIG. 4, in accordance with aspects of the present disclosure;

FIG. 6 is a process for extracting one or more physical properties from transmission images of solids extracted from the reservoir including a tracking model, in accordance with aspects of the present disclosure;

FIG. 7 is a process for optimizing a projection data set to extract one or more physical properties of one or more solids in projectile motion, in accordance with aspects of the present disclosure;

FIG. 8 is a schematic embodiment of projection and attenuation graphs used to illustrate optimization of projection data of estimated Gaussians and known projection data of an unknown Gaussian, in accordance with aspects of the present disclosure; and

FIG. 9 is a schematic embodiment of a screen displaying a GUI generated by the analysis system, in accordance with an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

As used herein, the term “processing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM).

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed continuously and/or automatically in substantially real time during operation of the computing system and/or equipment controlled by the computing system, it will be appreciated that these operations may, in fact, be performed continuously and/or automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

As described above, whenever a drilling process is involved in an activity, solids (e.g., rock cuttings) are produced and are generally available at the well site. Traditionally, solids are removed from the well site and, after going through a manual sample preparation process, characterized off-site using image analysis techniques to characterize solids to provide information related to geological subsurfaces associated with the well site. Removal of solids from the well site and sample preparation process generally prevent near real-time reconstruction of the subsurface properties (e.g., reservoir characteristics). As such, characteristics of solids are generally under-utilized for the subsurface characterization by geoscientists and reservoir engineers in the oil and gas industry. As such, a need exists for achieving near real-time analysis of structural properties of solids.

Accordingly, the present disclosure techniques may be used to acquire near real-time structural information of solids at a well-site. A tomography system is described herein that enables collection, interpretation, and reconstruction of structural properties of solids. The tomography system may include an imaging system and an analysis system to provide structural information of solids for use in identifying lithology types for use in subsurface characterization. In some embodiments, the imaging system may include sources and detectors to enable transmission tomography of solids extracted from a wellbore in near real-time. In some embodiments, the imaging system may form hyperspectral images through collection of transmission signals of solids at multiple energy levels. Such transmission tomography may be used to collect data associated with the solids in a non-destructive fashion. The hyperspectral images may be analyzed by the analysis system to provide structural data associated with the solids. The structural data may be interpreted to provide a digital representation of the reservoir and/or the geological formation and subsurface as a whole. As such, embodiments of the present disclosure relate to near real-time acquisition of spectral data of solids being extracted from a reservoir. In certain embodiments, the solids may be moving during spectral acquisition. For example, the solids may fall from a conveyor of a shale shaker into a reserve pit (e.g., container, sea). As such, embodiments herein are directed to implementation of the analysis system to identify, track, and characterize falling solids in near real-time to generate petrophysical and geological analysis of extracted solids. It should be noted, although described herein as systems and methods for analyzing images of solids, it will be appreciated that the embodiments described herein may be capable of analyzing images of different types of solids, such as cuttings, cavings, and so forth as well as non-rock objects in the mud, such as mud additives, metal shavings, and foreign objects.

In some embodiments, the analysis system may detect structural information that may be found in geological formations. For example, the tomography system may include a radiation based computerized tomography system. The analysis system may provide three-dimensional (3D) reconstruction to provide internal information of the solids. The solids may be measured directly as the solids fall from the shale shaker to the reserve pit without sample preparation. As such, near real-time interpretation of the solids may be provided to generate digital representations of the reservoir to inform drilling operations and/or enable near real-time control of a drilling system. Further, spectroscopic signatures obtained by the imaging system may be analyzed and associated with particular minerals found in the solids. That is, reconstruction of structural properties of the solids may provide insight of a structure of the geological formations. As described herein, near-real time acquisition of the structural properties of the solids may provide near real-time understandings of the geological formations, thereby helping to improve near real-time control of the drilling system. For example, the near real-time acquisition of the structural properties of the solids may be used by a control system of a drilling system to alter one or more aspects of a drilling operation, such changing a direction of drilling via a rotary steerable system (RSS), changing a speed of rotation of a drill bit, changing a flow rate of a drilling mud, controlling a pressure of the well, or any combination thereof. These understandings may be provided in seismic data images, which may be used to identify hydrocarbon deposits, map geological formations, and the like to expedite and improve hydrocarbon exploration and production operations.

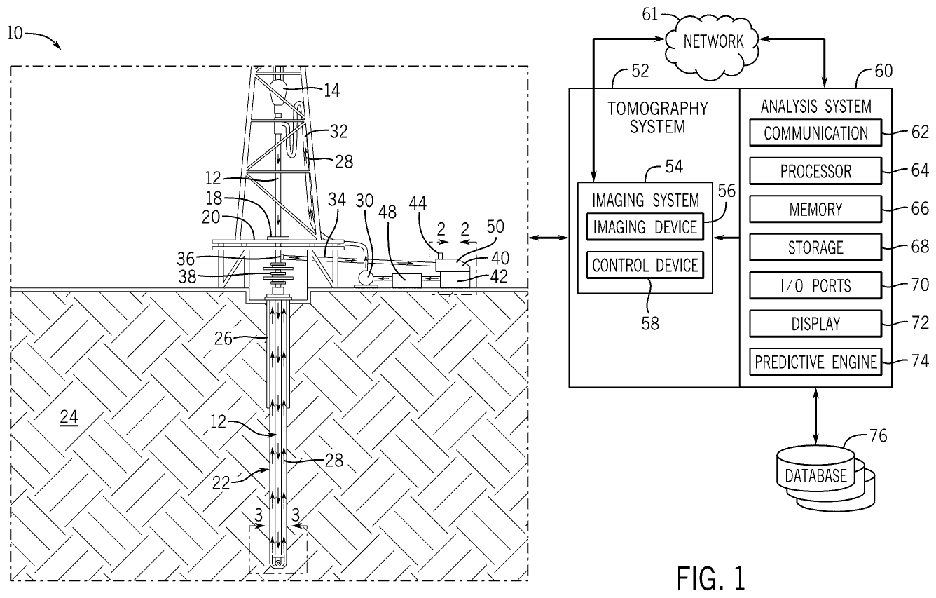

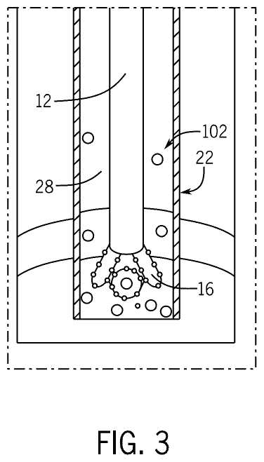

With this in mind, FIG. 1 is a schematic diagram illustrating a drilling system 10 in accordance with the embodiments described herein. As illustrated, in certain embodiments, a drill string 12 may be suspended at an upper end by a kelly and a traveling block 14 and terminated at a lower end by a drill bit 16 (shown in FIG. 3). The drill string 12 and the drill bit 16 are rotated by a rotary table 18 on a driller floor 20, thereby drilling a borehole 22 into earth formation 24, where a portion of the borehole 22 may be cased by a casing 26. As illustrated, in certain embodiments, drilling fluid or drilling “mud” 28 may be pumped by a mud pump 30 into the upper end of the hollow drill string 12 through a connecting mud line 32. From there, the drilling fluid 28 may be pumped downward through the drill string 12, exiting the drill string 12 through opening in the drill bit 16, and returning to the surface by way of an annulus formed between the wall of the borehole 22 and an outer diameter of the drill string 12. Once at the surface, the drilling fluid 28 may return through a return flow line 34, for example, via a bell nipple 36. As illustrated, in certain embodiments, a blowout preventer 38 may be used to prevent blowouts from occurring in the drilling system 10.

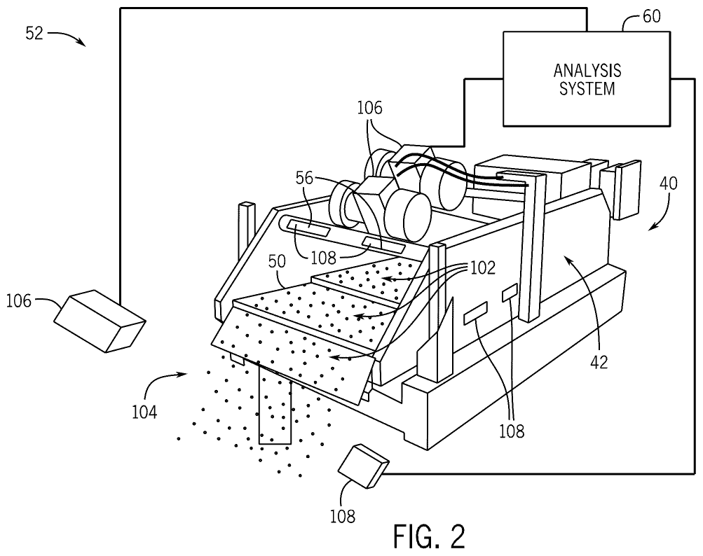

As illustrated in FIG. 1, solids that are formed by the drill bit 16 crushing rocks in the earth formation 24 may typically be removed from the returned drilling fluid 28 by a shale shaker 40 in the return flow line 34 such that the drilling fluid 28 may be reused for injection, where the shale shaker 40 includes a shaker pit 42 and a gas trap 44. The drilling fluid 28 may then be delivered to a mud pit 48 from which the mud pump 30 may draw the drilling fluid 28. The shale shaker 40 may include a conveyor 50, which may be used to transfer the solids for reinjection into the borehole 22. In some embodiments, the drilling system 10 may include a tomography system 52. The tomography system 52 may include all equipment associated with acquiring, preparing, imaging, and analyzing the solids. For example, the tomography system 52 may include an imaging system 54 and an analysis system 60. The imaging system 54 may include an imaging device 56 to take images of the solids. The imaging device 56 may include one or more sources, one or more detectors, or a combination thereof. The sources and detectors may be used for transmission tomography as described further in reference to FIGS. 2, 4, and 5. Spectral data obtained by the imaging device 56 may include hyperspectral images, images, optical signals, and the like. In some embodiments, the imaging device 56 may be any type of optical, transmission, or electronic microscope, camera, and the like. In some instances, the images obtained by the imaging device 56 may be digital images acquired by a camera. The camera may include an infrared camera, a CCD camera, a DSLR camera, a SLR camera, a mirrorless camera, or one or more digital cameras. The spectral data may be analyzed as discussed in further detail below.

The imaging system 54 may also include a control device 58 (e.g., processor-based controller) to control the imaging device 56 and operational conditions (e.g., lighting, temperature, moisture) associated with data acquisition by the imaging system 54. For example, the control device 58 may adjust the parameters (e.g., source intensity, exposure, focus, resolution, and the like) of the imaging device 56. The imaging system 54 may be located at an oil and gas work site positioned to capture spectral data of the solids moving on the conveyor 50, falling from the conveyor 50, and/or additional suitable configurations. The control device 58 may be located at the oil and gas work cite or at one or more remote locations. Further, the control device 58 may be communicatively coupled to the analysis system 60 to provide spectral data for further analysis, reconstruction, and output.

The analysis system 60 may be used to receive and analyze spectral data (e.g., hyperspectral images) from the imaging system 54 directly or via a network 61. The analysis system 60 may be located at the oil and gas work site or at one or more remote locations. The analysis system 60 may include a communication component 62, a processor 64, a memory 66, a data storage 68, input/output (I/O) ports 70, a display 72, a predictive engine 74, and the like. The network 61 may include transceivers, receivers, and/or transmitters to facilitate data communication to and/or from the analysis system 60. For example, spectral data from the imaging system 54 may be transmitted to the analysis system 60 through the network 61. Further, external data (e.g., data about a geologic formation) may be gathered from a remote system and transmitted to the analysis system 60 via the network 61. However, in some embodiments, data may be transmitted directly from the devices (e.g., the imaging system 54) to the analysis system 60. Indeed, the analysis system 60 may communicate with the devices directly and/or through the network 61 in accordance with present embodiments. In certain embodiments, the spectral data may be automatically communicated from the imaging system 54 to the analysis system 60 for analysis in real-time, thereby enabling real-time responses (e.g., adjusting the imaging system 54, retaking images that are unacceptable, controlling and adjusting the drilling system 10, etc.) to information obtained from analysis of the data.

The communication component 62 may be a wireless or wired communication component (e.g., circuitry) that may facilitate communication between the analysis system 60, various types of devices, the network 61, and the like. Additionally, the communication component 62 may facilitate data transfer to the analysis system 60, such that the analysis system 60 may receive data from the other components depicted in FIG. 1 and the like. The communication component 62 may use a variety of communication protocols, such as Open Database Connectivity (ODBC), TCP/IP Protocol, Distributed Relational Database Architecture (DRDA) protocol, Database Change Protocol (DCP), HTTP protocol, other suitable current or future protocols, or combinations thereof.

The processor 64 may include single-threaded processor(s), multi-threaded processor(s), or both. The processor 64 may process instructions stored in the memory 66. The processor 64 may also include hardware-based processor(s) each including one or more cores. The processor 64 may include general purpose processor(s), special purpose processor(s), or both. The processor 64 may be communicatively coupled to other internal components (such as the communication component 62, the data storage 68, the I/O ports 70, and the display 72).

The memory 66 and the data storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. As used herein, applications may include any suitable computer software or program that may be installed onto the analysis system 60 and executed by the processor 64. The memory 66 and the data storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like. The display 72 may operate as a human machine interface (HMI) to depict visualizations associated with software or executable code being processed by the processor 64. The display 72 may display a map of the geological formation data (e.g., images and information derived from the images) corresponding to positions on the map, alerts/alarms when image data is not acceptable, recommendations associated with the alerts/alarms, etc. In one embodiment, the display 72 may be a touch display capable of receiving inputs from an operator of the analysis system 60. The display 72 may be any suitable type of display, such as a liquid crystal display (LCD), plasma display, or an organic light emitting diode (OLED) display, for example. Additionally, in one embodiment, the display 72 may be provided in conjunction with a touch-sensitive mechanism (e.g., a touch screen) that may function as part of a control interface for the analysis system 60.

The predictive engine 74 may use various machine learning algorithms to analyze images obtained for the solids to identify lithology of the rock samples. The predictive engine 74 may utilize one or more predictive models for analysis of the variety of data received by the analysis system 60. Various types of predictive models may be used to analyze data from variety of resources and generate predictive outputs. For example, the predictive engine 74 may be trained with supervised machine learning technique, i.e., a predictive model is trained with training data that includes input data and desired predictive output (e.g., labeled dataset). The predictive engine 74 may also be trained with unsupervised machine learning technique, i.e., a predictive model is trained with training data that includes input data but without desired predictive output (e.g., unlabeled dataset). The predictive engine 74 may include various types of artificial neural networks (ANN), such as Convolution Neural Networks (CNN), Recurrent Neural Networks (RNN), etc. The analysis system 60 may also communicate with one or more database 76, which may store information associated with the drilling system 10, related external resources (e.g., geologic formation history), etc.

It should be noted that the components described above with regard to the tomography system 52 are exemplary components and the tomography system 52 may include additional or fewer components as shown. In addition, although the components are described as being part of the analysis system 60, the components may also be part of any suitable computing device described herein such as the shale shaker 40, the conveyor 50, the imaging device 56, the control device 58, and the analysis system 60, and the like to perform the various operations described herein.

FIG. 2 is a schematic diagram illustrating an embodiment of the tomography system 52. The tomography system 52 may be coupled to the shale shaker 40. The shale shaker may 40 be used to remove one or more solids 102 from drilling fluid. The shale shaker 40 may include the conveyor 50. The conveyor 50 may move the solids 102 through the shale shaker 40 to an outlet 104. As shown, the imaging system 54 and the analysis system 60 as described in FIG. 1 may be positioned proximate to the shale shaker 40. As such, the tomography system 52 may generate and process spectral data of the solids 102 removed from the drilling fluid 28 in the shaker pit 42 of the shale shaker 40. With this in mind, FIG. 3 is a schematic embodiment of a drill bit 16 generating solids 102. As shown, the drill bit 16 generates the solids 102 that may flow back up within the drilling fluid 28 through an annulus formed between the wall of the borehole 22 and an outer diameter of the drill string 12. As such, the solids 102 may be used to assess structural information related to the borehole 22. In this manner, understanding of structural information of the solids 102 may provide insight to the reservoir being drilled. For example, as the drill bit 16 breaks through layers of sediment, structural information surrounding the borehole 22 may vary with depth. As such, it may be advantageous to analyze the solids 102 in near real-time to provide data associated with the reservoir to inform drilling operations, such that a control system can adjust one or more operational parameters of the drilling system 10 in near real-time based on the analysis of the solids 102. In this manner, as the solids 102 flow up within the drilling fluid 28 the tomography system 52 may be used to image and analyze the solids 102 in near real-time.

Returning now to FIG. 2, in some embodiments, the tomography system 52 may include one or more imaging devices 56. The imaging devices may include one or more sources 106 and one or more detectors 108 to capture spectral data of the solids 102. The sources 106 may include one or more X-ray sources, neutron source, one or more gamma ray sources, one or more positron sources, and/or additional suitable energy sources. The detectors 108 may be configured to include one or more detector arrays, one or more long detector, multiple small detectors, a pushbroom detector (e.g., configured to generate a hyperspectral data cube of spatial and spectral information), a point detector, one or more cameras, and the like. The detectors 108 may include one or more xenon gas detectors, one or more solid state detectors, one or more scintillators, one or more a thermal imager, a complementary metal-oxide-semiconductor (CMOS) camera, a charge-coupled device (CCD), electron-multiplier charge-coupled device (EMCCD), one or more photodiodes, pyroelectric sensors, one or more photodetectors, a photomultiplier tube (PMT), and/or other suitable detectors. It should be noted, in some embodiments, the sources 106 and the detectors 108 may be housed in a single housing. For example, a camera may be used as both a source and a detector to capture image data of the solids 102.

In some embodiments, the imaging devices 56 (e.g., the sources 106, the detectors 108) may be controlled by one or more control devices 58. The control devices 58 may control a position of the imaging devices 56. For example, the sources 106 may be fixed or movable in relation to the shale shaker 40. As shown, the sources 106 may be positioned to image the solids 102 moving on the conveyor 50, falling out the outlet 104 of the shale shaker 40, or a combination thereof. Further, in some embodiments the detectors 108 may be positioned opposite of the sources 106. In this manner, the sources 106 may collect signals generated as a result of transmission of energy from the source 106 through the solids 102. In some embodiments, the detectors 108 may be positioned at one or more angles from the sources 106, the solids 102, the shale shaker 40, and the like to collect signals as a result of source interaction with the solids 102 (e.g., energy source/matter interaction). As shown, the sources 106 and the detectors 108 may be positioned to capture signals (e.g., transmission signals) as the solids 102 fall from the outlet 104 of the shale shaker.

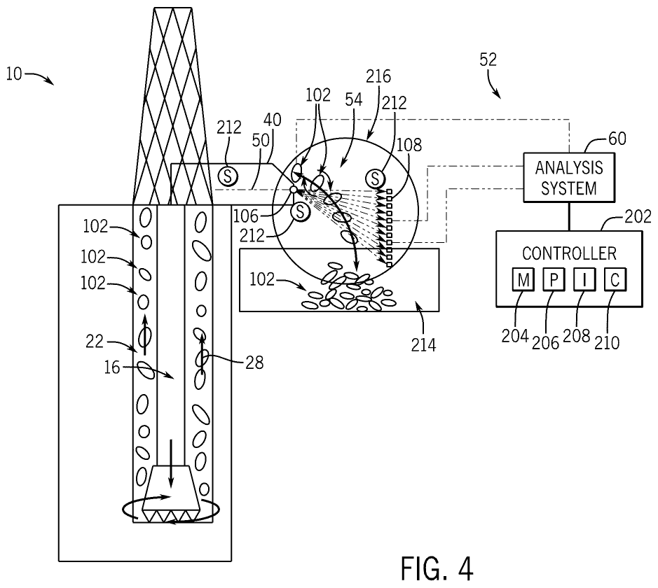

In addition, as illustrated in FIG. 1, in certain embodiments, the analysis system 60 (e.g., a mud logging unit) may be used to control the drilling system 10, as well as provide analysis of the solids 102, as described in greater detail herein. In particular, in certain embodiments, the analysis system 60 may be configured to automatically analyze images of the solids 102 that are automatically captured by the image devices 56 during operation of the drilling system 10. With this in mind, FIG. 4 is a schematic diagram illustrating a drilling system 10 including the tomography system 52. In some embodiments, operations of the drilling system 10, the tomography system 52, the imaging system 54, the analysis system 60, or a combination thereof, may be controlled via a controller 202. The controller 202 includes memory 204, one or more processors 206, instructions 208 stored on the memory 204 and executable by the processor 206, and communication circuitry 210 configured to communicate with sensors, imaging devices 56, and various equipment of the drilling system 10. For example, the controller 202 is configured to receive sensor feedback from one or more sensors 212 coupled to the shale shaker 40, the conveyor 50, the tomography system 52, the imaging system 54, the analysis system 60, and/or additional components of the drilling system 10 and control the same equipment based on the sensor feedback, operating modes, user input, computer models, or any combination thereof. The sensors 212 may include surface sensors (Internet of Things (IOT) sensors, gauges, and so forth) and/or downhole sensors, or any combination thereof.

As shown in FIG. 4, solids 102 may be extracted with the drilling fluid 28 as the drill bit 16 rotates through the borehole 22. Once at the surface, the solids 102 and the drilling fluid 28 may be directed to the shale shaker 40 to separate the solids 102 from the mud within the drilling fluid 28. As such, the solids 102 may move along the conveyor 50 and drop into a reserve pit 214. The solids 102 during movement from the conveyor 50 to the reserve pit 214 may be considered falling solids (e.g., solids in projectile motion). The projectile motion is attributed to both the force applied to the solids 102 by the conveyor 50 and gravity applied to the solids 102 after separating from the conveyor 50, and thus the solids 102 may follow a generally curved path of motion upon separating from the conveyor 50. In addition to the generally curved path of motion, the solids 102 also may generally roll or rotate as the solids fall into the reserve pit 21. As discussed in detail below, the tomography system 52 uses the generally curved path of motion combined with additional rotation of the solids 102 to improve imaging of the solids 102. In some embodiments, the reserve pit 214 may include a container, a sea, or an additional suitable holder for the solids 102 separated from the drilling fluid 28. In some instances, the solids 102, the drilling fluid 28, the mud, or a combination thereof, may be reinjected into a well.

In certain embodiments, as the solids 102 move from the conveyor 50 to the reserve pit 214, tomography data may be generated by the tomography system 52. For example, the imaging system 54 may image the solids 102 while in motion between the conveyor 50 and the reserve pit 214. The solids 102 may be moving via projectile motion, freefall, and the like from the conveyor 50 to the reserve pit 214. In certain embodiments, the solids 102 may move (e.g., fall) through an imaging zone 216. The imaging zone 216 may include components of the imaging system 54, such as the sources 106 and the detectors 108. The sources 106 may be controlled by the controller 202 to irradiate the solids 102 as they move through the imaging zone 216. The detectors 108 may be controlled by the controller 202 to collect one or more transmission images based on the interaction of the sources 106 with the solids 102 falling through the imaging zone 216. In some embodiments, the transmission images may be provided to the analysis system 60. The analysis system 60 may use a tracking model to predict a location of the solids 102 moving through the imaging zone 216 during acquisition of the transmission images. As such, the analysis system 60 may perform image reconstruction of the transmission images that may be used to infer physical properties of the solids 102 extracted from the wellbore 22.

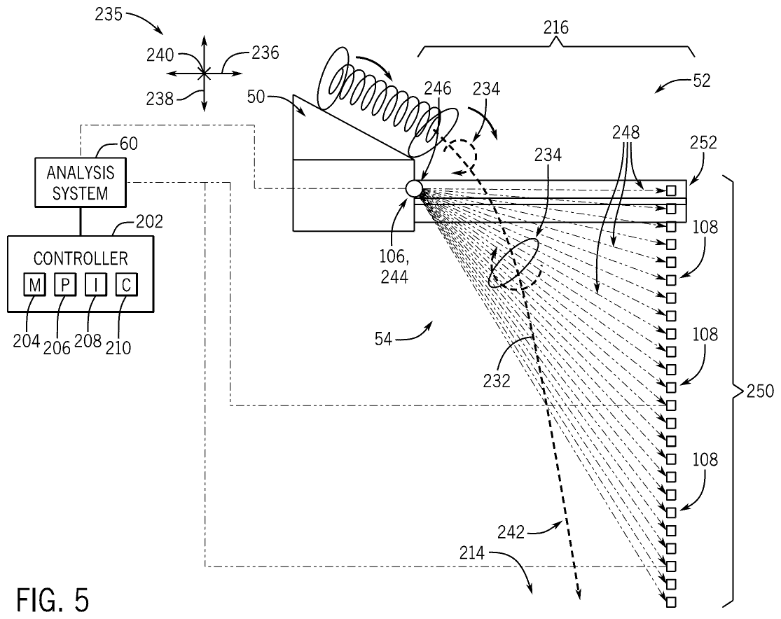

FIG. 5 is a schematic diagraph illustrating the solids 102 in projectile motion and the tomography system 52 of FIG. 4. As shown, the solids 102 may follow a projectile motion 232 (e.g., generally curved path of travel) from the conveyor 50 to the reserve pit 214 while also experiencing a rotational motion 234, which may be constant or variable as the solids 102 move along the projectile motion 232. For example, the rotational motion 234 may be continuously variable along the projectile motion 232, wherein the rotational motion 234 may include rotation about one or more axes of rotation 235 (e.g., 236, 238, and 240). For example, the solids 102 may rotate along a lateral axis 236 of the solid 102, a lengthwise axis 238 of the solid 102, a diagonal axis 240 of the solid 102, or a combination thereof. As the solids 102 rotate about the various axes 235 (e.g., 236, 238, 240) of the solids 102, the solids may follow one or more trajectories 242 of the projectile motion 232. The trajectories 242 of each solid of the solids 102 may be based on a speed of projectile motion, a density, a weight, a shape, a size, one or more additional properties of the solid, or a combination thereof. The trajectories 242 of each solid of the solids 102 extracted from the wellbore 22 may follow different trajectories as they fall from the conveyor 50 to the reserve pit 214. As such, the imaging system 54 may capture transmission images of the solids 102 in projectile motion 232 at different points in time corresponding to different points of rotation, location, and the like.

With this in mind, the imaging system 54 may be configured to continuously acquire transmission images as the solids 102 move through the imaging zone 216. The imaging system 54 of the tomography system 52 may include one or more sources 106 and one or more detectors 108. In certain embodiments, a single source 106, 244 may be positioned at an outlet 246 of the conveyor 50. The single source 106, 244 may be controlled by the controller 202 to continuously irradiate the solids 102 with one or more energy levels 248. The one or more energy levels 248 may exit the single source 106, 244 and enter the imaging zone 216 at one or more angles. The angles may be based on an incident angle of the energy levels 248 exciting the single source 106, 244, interaction with an environment of the imaging zone 216, or a combination thereof. The energy levels 248 may transmit through the imaging zone 216 to a detector array 250. The detector array 250 may include one or more detectors 108, such as equal to or greater than 1, 5, 10, 15, 20, or more detectors 108. The detector array 250 may be configured to receive one or more energy levels 248 transmitted by the single source 106. In some instances, the detector array 250 may continuously collect transmission images of the solids 102. In this manner, the detector array 250 may collect attenuation data of the solids 102 interacting with the energy levels 248 generated by the single source 106, 244 in space, time, or a combination thereof. As such, the transmission images collected may be used to provide temporal and spatial information of the solids 102. It should be noted, that while in the illustrated embodiment, a single source 106 is described, one or more additional sources 106 may be included in the imaging system 54 to irradiate the solids 102. As such, one or more additional detectors 108 may be included to measure attenuation of the energy levels 248 generated by the sources 106. Further it should be noted, that in certain embodiments, transmission tomography of the solids 102 may be achieved using a static imaging configuration as discussed in reference to FIG. 4. In this manner, the static imaging configuration may use the sources 106 and the detectors 108 positioned at different angles to collect various perspectives of the solids 102 as they move along the conveyor 50. Additionally and/or alternatively, the controller 202 may direct the imaging system 54 to move the sources 106 and the detectors 108 during acquisition of the transmission images. Movement of the sources 106, the detectors 108, or a combination thereof, may allow multiple angles of the solids 102 to be captured during transmission imaging. As such, the sources 106 and/or the detectors 108 may be configured to rotate or move during transmission image acquisition. However, the projectile motion 232 combined with the rotational motion 234 of the solids 102 helps to improve imaging of the solids 102 by the imaging system 54 with or without movement (e.g., rotation) of the sources 106 and the detectors 108 relative to the drilling system 10, the conveyor 50, and the solids 102.

In certain embodiments, the detector array 250 may collect transmission images with one or more scans 252 (e.g., directional transmission attenuation scans). As shown, the scans 252 may include one or more spatial areas of the imaging zone 216. As such, the transmission images my include one or more scans 252 that build up a data cube of both spatial and spectral information relating to attenuation of the solids 102 with the energy levels generated by the sources 106 during imaging. In this way, analysis of the transmission images may provide spectral, temporal, and attenuation data of the solids 102 in projectile motion. As such, the analysis system 60 may receive the transmission images and perform image analysis via the tracking model to determine a location of each solid 102 in the projectile motion 232 to extract attenuation data that may be used to infer structural characteristics of the solids 102 for use in generating a digital representation of the reservoir (e.g., the wellbore 22).

In some embodiments, the analysis system 60 may analyze, track, reconstruct, and provide structural, lithographic, and/or physical information to the tomography system 52 to control operations of the drilling system 10. A tracking model may be may be used to correlate projectile motion 232 of a particular solid 102 with attenuation properties of the particular solid 102. As such, the tracking model may be used to determine a location of the particular solid 102 during projectile motion 232 (e.g., including rotational motion 234, free fall, or a combination thereof). The location of the particular solid 102 may be used during reconstruction of the transmission images and/or output of structural characteristics of the particular solid 102. The tracking model may be designed to predict the location of the particular solid 102 based on a predicted speed of motion and/or rotation of the particular solid 102 as it falls off the conveyor 50. In some embodiments, the tracking model may analysis the scans 252 of the transmission images and extract the trajectories 242 of the solids 102 in projectile motion 232. The solids 102 may be modeled as one or more Gaussians to provide the location of the solids 102 for use in image reconstruction of the transmission images. As such, the solids 102 may be approximated as one or more isotropic Gaussians that may be affinely transformed with one or more unknown parameters. It should be noted, that in some embodiments, generalization may extend the tracking model to model the solids 102 with a Gaussian mixture model where the Gaussian mixture model may be affinely transformed.

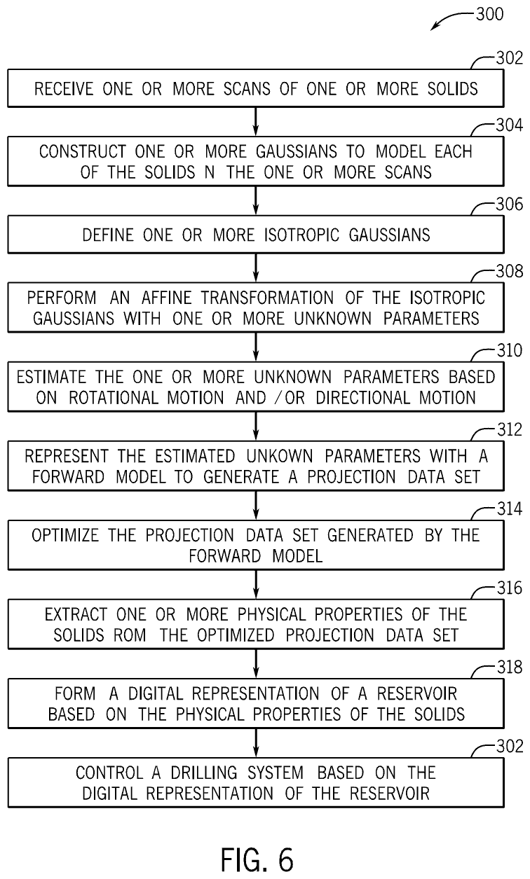

FIG. 6 is a flow chart of an embodiment of a process 300 for extracting one or more physical properties from transmission images of the solids 102 extracted from the reservoir including a tracking model. The process 300 may be performed by a computing device or controller disclosed above with reference to FIG. 1 and/or FIG. 4, or any other suitable computing device(s) or controller(s). Furthermore, the blocks of the process 300 may be performed in the order disclosed herein or in any suitable order. For example, certain blocks of the process may be performed concurrently. In addition, in certain embodiments, at least one of the blocks of the process 300 may be omitted.

At block 302 of the process 300, the tomography system 52 may receive one or more scans 252 of the one or more solids 102 acquired by the imaging system 54. In some instances, the scans 252 may be provided to the analysis system 60 of the tomography system 52. Further, in some embodiments, the scans 252 may one or more portions of one or more transmission images acquired by the imaging system 54. At block 304 of the process 300, the tomography system 52 may construct one or more Gaussians to model each of the one or more solids 102 in the scans 252. In some embodiments, the analysis system 60 of the tomography system 52 may perform analysis on the scans 255 using a tracking model.

At block 306 of the process 300, the tracking model of the tomography system 52 may define one or more anisotropic Gaussians. The one or more anisotropic Gaussians may be estimated based on a fixed acquisition geometry. In this manner, the source 106 and the detector 108 are in a static position. As such, the fixed static acquisition geometry may be defined by Equation 1,

$$\{ {( s , {r}_{k} )}_{k = 1}^{K} \} \qquad Equation 1$$

where s is the position of the source 106, 244 and r is the position of the detector array 250. In some embodiments, the anisotropic Gaussian may be defined by an affine transformed version of an isotropic Gaussian. An isotropic Gaussian may be defined by multidimensional Gaussian distribution with each dimension treated as an independent one-dimensional Gaussian distribution (e.g., no covariance). As shown in Equation 2, the isotropic Gaussian may be expressed by

$${f}_{0} ( z ) = exp ( - {z}^{T} z ) for z ∈ {ℝ}^{d} \qquad Equation 2$$

where z is the mean vector.

At block 308 of the process 300, the tracking model may perform a projectile motion on an affine transformation of the isotropic Gaussian with one or more unknown parameters. The one or more unknown parameters may include one or more properties of rotational motion, directional motion, dilation, scaling, amplitude and/or one or more suitable properties. Performing affine transformation of the isotropic Gaussians may capture geometric and material signatures of the solids 102 in projectile motion, as shown in FIG. 5. Equation 3 provides an example of an affine transformation operator that may be used to transform Equation 2,

$$( {𝒜}_{θ} f ) ( z ) := α f ( Uz - ζ ) \qquad Equation 3$$

where θ is a vector of the unknown parameters with respect to a fixed and/or known ordering.

In certain embodiments, the affine transformation of Equation 3 may be applied to Equation 2 as shown in Equation 4,

$$( {𝒜}_{θ} f ) ( z ) := α exp ( - {( z - ξ )}^{T} {U}^{T} U ( z - ξ ) ) \qquad Equation 4$$

where ξ is U⁻¹ζ and ζ is projectile motion.

At block 310 of process 300, the tracking model may estimate the unknown parameters based on rotational motion and/or directional motion. Directional motion includes movement in a specific direction. As such, directional motion may include translation of the solids 102 in one or more directions. Directional motion may include movement of the solids as represented by the projectile motion 232 as shown in FIG. 5 which may consider the gravitational vector. In some embodiments, to estimate the unknown parameters of each of the one or more anisotropic Gaussians an initial position, x₀, and/or dilation A₀. In some embodiments, the unknown parameters may be estimated following Equation 5.

$$( {𝒜}_{θ} g ) ( x ) = exp ( - \frac{{[ {A}_{0} [ x - {x}_{0} ] ]}^{T} [ {A}_{0} [ x - {x}_{0} ] ]}{2} ) for , {x}_{0} ϵ {ℝ}^{N} , {A}_{0} P S D \qquad Equation 5$$

where PSD is positive symmetric definite matrix.

In some embodiments, the projectile motion and the directional motion may be estimated as shown in Equation 6.

$$ζ ( t ) = {x}_{0} + {v}_{0} t + \frac{1}{2} {a}_{0} {t}^{2} \qquad Equation 6$$

where t is the time and v₀ is a velocity, a₀ is an acceleration which may also encompass gravity. Additionally and/or alternatively a constant two-dimensional rotational motion may be estimated following Equation 7,

$${R}_{ω} ( t ) = ( \begin{matrix}cos ( ω t ) & - sin ( ω t ) \\ sin ( ω t ) & cos ( ω t )\end{matrix} ) \qquad Equation 7$$

where ω is the angle of rotation. Furthermore, three two-dimensional rotations can be combined in three-dimensions to estimate a constant three-dimensional rotational motion.

In certain embodiments, the rotational motion may be described by a dynamic affine operator as shown in Equation 8.

$$( {𝒟}_{θ} ( t ) f ) ( z ) := α f ( {UR}_{ω}^{T} ( t ) ( z - ζ ( t ) ) \qquad Equation 8$$

where ƒ is a Gaussian. Further, as shown in Equation 9 a time-dependent function may be used to define time dependency for each Gaussian,

$${u}_{θ} ( z , t ) = ( {𝒟}_{θ} ( t ) {f}_{0} ) ( z ) \qquad Equation 9$$

where ƒ is a Gaussian.

At block 312 of the process 300, the tracking model may represent the estimated unknown parameters (e.g., parameters related to directional motion and/or rotational motion) with a forward model. The forward model may be used for reconstruction of the scans 252 by constraining reconstruction based on a set of input variables. The forward model may be applied iteratively for each Gaussian and/or each iteration of reconstruction of the scans 252. The forward model may transform the estimated unknown parameters through forward projection in a process that may mimic the solids 102 in projectile motion. As such, the forward model may form a projection data set that mimics falling of the solids 102 from the conveyor 50 to the reserve pit 214. In certain embodiments, the forward model may be expressed as shown in Equation 10,

$$( Xu ( \cdot , t ) ) ( s , r ) := \int {\int }_{- ∞}^{∞} u ( s + x ( ) , t ) dx , for \hat{z} = z / \vert z \vert \qquad Equation 10$$

where a closed formula for anisotropic Gaussian in motion is given by Equation 9 where is (Xu(s,r) is a Gaussian with respect to r for fixed s, where s is the position of the source 106, 244 and r is the position of the detector array 250. It should be noted, that the forward model may produce the projection data set that may predict the location of solids 102 in projectile motion. In some instances, the projection data set may be optimized to minimize mismatch between the projection data set and a ground truth of the location of the solids 102.

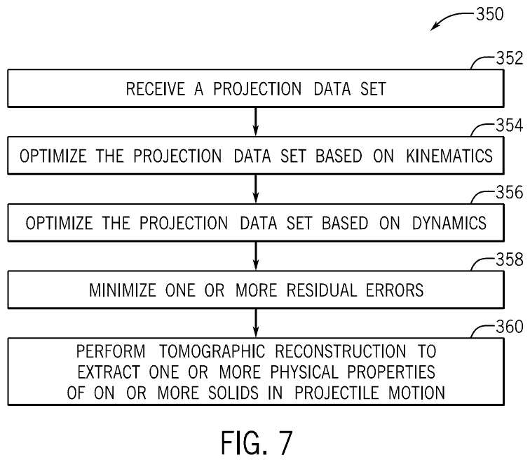

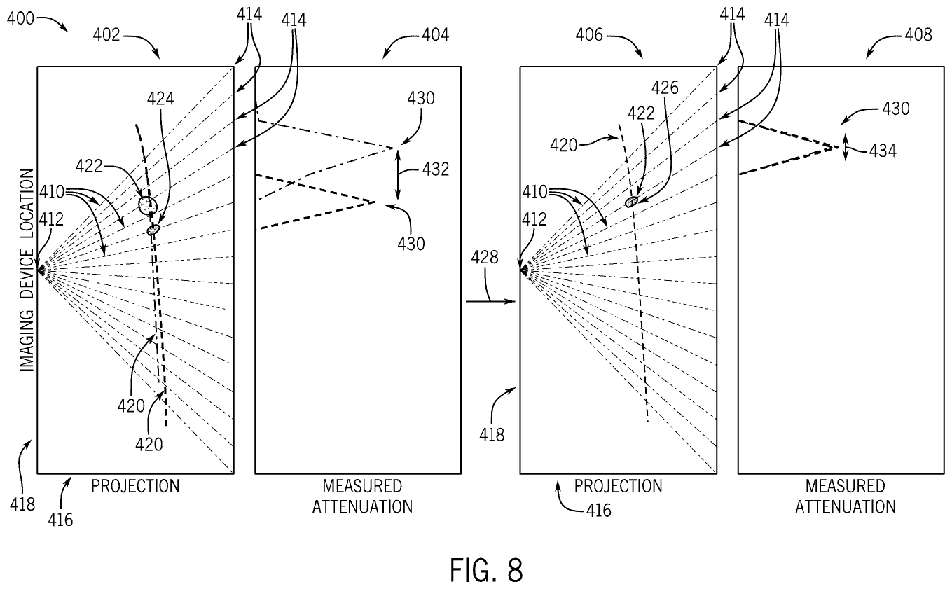

At block 314 of the process 300, the tracking model may optimize the projection data set generated by the forward model. In some embodiments, optimization of the projection data set may be based on optimization of one or more parameters associated with the Gaussians modeling the one or more solids 102, described below in FIGS. 7 and 8. The optimization may include a sequential optimization process. The sequential optimization process may include optimization for the directional motion by optimizing only for projectile trajectory parameters for an anisotropic Gaussian for a given loss function. Additionally and/or alternatively, the sequential optimization process may simultaneously optimize for the rotational motion, the projectile motion, and one or more affine transform parameters for a given loss function. Further, the sequential optimization process may include minimizing remaining residual errors with a loss function.

At block 316 of the process 300, the tomography system 52 may extract one or more physical properties of the solids from the optimized projection data set. The physical properties may include a porosity, a saturation (e.g., water saturation), a permeability, mineralogy, lithology, density, and the like of the solids 102 extracted from the reservoir. The physical properties of the solids 102 may be used to predict characteristics and parameters for the geologic formation. At block 318 of the process 300, the tomography system 52 may form a digital representation of the reservoir based on the physical properties of the solids 102. The digital representation may include a detailed record, a master log file, and the like for the reservoir (e.g., geologic formation). The digital representation may include information regarding the geologic properties (e.g., lithology, layer, depositional environments) and petrophysical characterization (e.g., water saturation, porosity, permeability, volume of shale) of the reservoir, which may be used to control the drilling system 10 or a drilling plan of the drilling system 10. At block 320 of the process 300, the tomography system 52 may control a drilling system 10 based on the digital representation of the reservoir. To obtain accurate results, a large amount of transmission images of the solids 102 may be analyzed to provide near real-time analysis of properties of the reservoir. As such, the drilling system 10 may be controlled based on continuous generation of digital representations of the reservoir during drilling operations using the drilling system 10.

Referring now to FIG. 7, the tomography system 52 may perform a process 350 for optimizing a projection data set to extract one or more physical properties of one or more solids 102 in projectile motion 232. The process 350 may be performed by a computing device or controller disclosed above with reference to FIG. 1 and/or FIG. 4, or any other suitable computing device(s) or controller(s). Furthermore, the blocks of the process 350 may be performed in the order disclosed herein or in any suitable order. For example, certain blocks of the process may be performed concurrently. In addition, in certain embodiments, at least one of the blocks of the process 350 may be omitted.

At block 352 of the process 350, the tomography system 52 may receive a projection data set. In some embodiments, the projection data set is formed as described above in reference to FIG. 6. The projection data set may be generated based on modeling rotational motion and/or directional motion of the solids 102 in the projectile motion 232 by the tracking mode. As such, the scans 252 may be used to infer information about attenuation properties, geometrical properties, motion parameters, or a combination thereof. In this manner, the projectile motion 232 may include data that may mimic falling of the solids 102 from the conveyor 50 to the reserve pit 214.

At block 354 of the process 350, the tomography system 52 may optimize the projection data set based on kinematics. Optimization of the projection data set based on kinematics may consider the solids 102 as free-falling objects. As such, optimization may neglect causes of rotational motion. In some embodiments, ƒ₀(z) of Equation 9 may be e^{-zTz} may be used to construct an initial Gaussian flow based on the unknown parameters. At known times,

$${( {t}_{i} )}_{i = 1}^{N} ,$$

one or more samples (e.g., the solids 102 in projectile motion 232) may be observed. FIG. 12 may represent one or more hypothetical projections at each time, t,

$${g}_{θ} ( {s}_{0} , {r}_{i , j} ) := ( {Xu}_{θ} ( \cdot , t ) ) ( s , {r}_{i , j} ) \qquad Equation 11$$

where j=1, . . . . M, and g_{θ}=∪_{i,j} g_{θ}(s₀, r_{i,j}), where g_{θ} describes a collection of indirect observation of the unknown parameters, θ, via the projection data set and repeat estimation of θₙ of θ to get g_{θ}_{ₙ}. As such, θₙ may be found through minimizing one or more loss functions, [symbol] (g_{θ}, g_{θ}_{ₙ}). In this manner, the projection data set (e.g., trajectory estimate) may be optimized to generate a first iteration, θ₁, of the unknown parameters that may be used to update the projection data set.

At block 356 of the process 350, the tomography system 52 may optimize the projection data set based on dynamics. Optimization of the projection data set based on dynamics may consider one or more forces that may impact the solids 102 during projectile motion 232. As such, optimization may include causes of motion. In some embodiments, optimization of the projection data set may construct the initial Gaussian flow based on the unknown parameters as discussed with respect to Equation 11. The constructed initial Gaussian flow may be optimized based on full dynamics to compute a second iteration, θ₂, of the unknown parameters that may be used to updated the projection data set by minimizing one or more additional loss functions, [symbol] (g_{θ}, g_{θ}_{₁}).

At block 358 of the process 350, the tomography system 52 may minimize one or more residual errors. The residual errors may be based on one or more additional properties (e.g., in addition to rotational motion and directional motion). As such, optimization of the projection data set may construct the initial Gaussian flow based on the unknown parameters as discussed with respect to Equation 11 and substitute the first iteration, θ₁, with the second iteration, θ₂. For example, an additional loss functions, [symbol] (g_{θ}, g_{θ}_{₂}) may be used to minimize the residual errors. At block 360 of the process 350, the tomography system 52 may perform tomographic reconstruction using the optimized projection data set to extract one or more physical properties of the solids 102 in projectile motion 232. Tomographic reconstruction may provide insight to the porosity, the saturation, the permeability, and/or one or more additional parameters related to the solids 102 extracted from the reservoir, thereby enabling more efficient and accurate control of the drilling system 10.

FIG. 8 is a schematic embodiment 400 of projection and attenuation graphs used to illustrate optimization of projection data of estimated Gaussians and known projection data of an unknown Gaussian. In some embodiments, the tomography system 52 may generate one or more graphs that may include a first projection graph 402, a first attenuation graph 404, a second projection graph 406, and a second attenuation graph 408. It should be noted, that one or more iterations of the projection and attenuation graphs may be produced by the tomography system 52 and the illustrated graphs provide one non-limiting embodiment. As shown on the first projection graph 402 and the second projection graph 406, one or more rays 410 connecting a source 412 to a detector 414 are illustrated to represent the imaging zone 216 of the imaging system 54 as described with reference to FIGS. 4 and 5. In some embodiments, the one or more rays 410 connecting the source 412 to the detector 414 may correspond to the one or more energy levels 248. In certain embodiments, the rays 410 may represent one or more locations in two-dimensional space. As shown, the x-axis 416 corresponds to projection in two-dimensional space and the y-axis 418 corresponds to the location of the imaging devices 56 in two-dimensional space. The first projection graph 402 and the second projection graph 406 may include one or more trajectories 420. The one or more trajectories 420 may represent models of the trajectories 242 of the solids 102 in projectile motion 232, as shown in FIG. 5.

It should be noted, that in some embodiments, a distance between the rays 410 may be varied (e.g., increased, decreased) to modify a resolution of predictions made of the Gaussians. As such, increasing a number of rays may decrease the distance between the rays 410 and may increase a resolution, a precision, a predictive power or a combination of predictions of the tomography system 52. In certain embodiments, decreasing the number of rays may increase the distance between the rays 410 and may decrease the resolution, the precision, the predictive power, or a combination thereof. As such, the tomography system 52 may perform optimization of the number of rays to determine a balance between the predictive power of estimates of the Gaussian and a computing power required to analyze the transmission images and model the Gaussians.

In some embodiments, a first projection data set may be presented on the first projection graph 402. As such, a first estimate 422 and a known position 424 of a modeled Gaussian may illustrate a first comparison of a Gaussian with a predicted location and a Gaussian with a known location. A second projection data set may be presented on the second projection graph 406. As such, a second estimate 426 and the known position 424 of a modeled Gaussian may illustrate a second comparison of a Gaussian with a predicted location and a Gaussian with a known location. In some embodiments, the second projection data set may be an optimized version of the first projection data set, as denoted by an arrow 428. The optimization may be performed following the process 350, as described above in regards to FIG. 7.

In certain embodiments, the first attenuation graph 404 and the second attenuation graph 408 may include one or more Gaussian estimations 430 corresponding to the first estimate 422, the second estimate 426, and the known position 424. As such, the first attenuation graph 404 and the second attenuation graph 408 illustrate optimization of the first comparison of the Gaussian and the second comparison of the Gaussian. As shown, optimization of the first projection data set decrease a first difference 432 between the first estimate 422 and the known position 424 of the first attenuation graph 404 in comparison to a second difference 434 between the second estimate and the known position 424 in the second attenuation graph 408. As such, the tomography system 52 may iteratively optimize the estimate positions 422, 426 of each Gaussian during reconstruction of the transmission images. It should be noted, that in certain embodiments, estimation of the Gaussian may be executed from clean and/or noisy data. The first projection data set and the second projection data set illustrate clean data, however, similar methods may be applied to projection data with one or more sources of noise (e.g., electronic noise, quantum noise, shot noise).

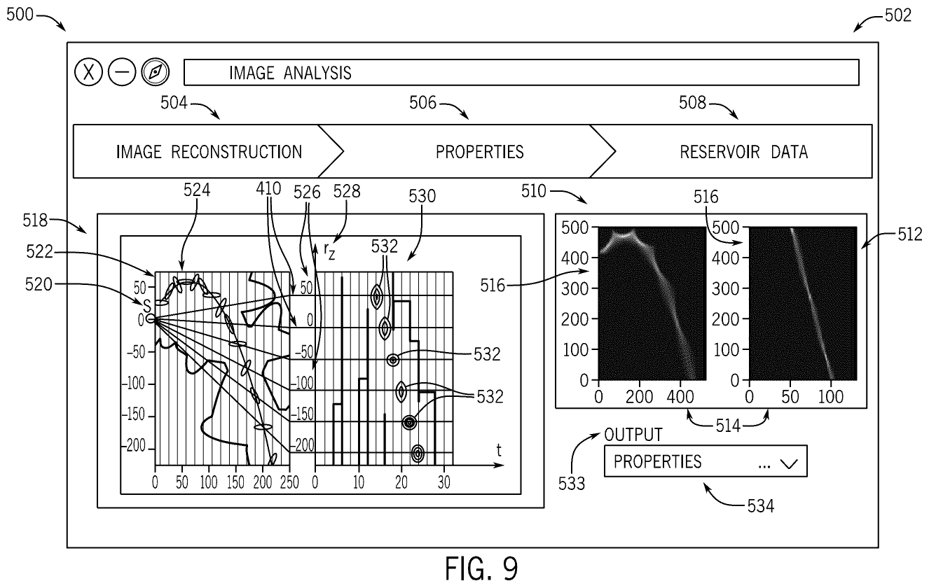

FIG. 9 is an illustrative embodiment of a user interface 500 of an electronic display device of the tomography system 52. The user interface 500 may include a dashboard 502 (e.g., command center) that may be used to visualize the tomographic images before and/or after image reconstruction. In this manner, the tomography system 52 provides centralized feedback to the users via the dashboard 502. The dashboard 502 may include various widgets (e.g., user interface widgets) providing alerts, notifications, status updates, image reconstructions, structural data, and the like.

In some embodiments, the various widgets of the dashboard 502 include an image reconstruction widget 504, a properties widget 506, a reservoir data widget 508, one or more additional widgets, or a combination thereof. As shown, the image reconstruction widget 504 may be selected to display one or more reconstructed images 510. The reconstructed images 510 may provide structural information of the solids 102 imaged by the tomography system 52. The reconstructed image 510 may be used to extract information about the structural properties of the solids 102 such as the porosity, the saturation, the permeability, and the like. The reconstructed images 510 may be presented as a heat map 512 of a Gaussian recovered from a transmission image acquired by the imaging system 54. The heat map 512 may illustrate tracking of a particular solid over in space (e.g., x-axis 514, y-axis 516). In some embodiments, the heat map 512 may include time-resolved information based on trajectories of the solids 102 in time as they move through the imaging system 54.

In some embodiments, the image reconstruction widget 504 may also include a motion accumulation graph 518. The motion accumulation graph 518 may include a source position 520 on the y-axis 522 and a trajectory 524 of an estimated Gaussian in two-dimensional space. The motion accumulation graph 518 may also include the rays 410 connecting the source position 520 to one or more detectors 526. In certain embodiments, a ray transformation may be performed along a detector plane 528 of the motion accumulation graph 518 to illustrate a ray transform plot 530 of a single Gaussian in projectile motion. The ray transform plot 530 may include the single Gaussian moving in time as illustrated by one or more Gaussian heat maps 532.

In certain embodiments, one or more properties (e.g., structural properties) may be extracted from the reconstructed image 510, the heat map 512, the motion accumulation graph 518, the ray transform plot 530, or a combination thereof. In some instances, a user may select an output 533 corresponding to one or more properties 534. In this manner, the dashboard 502 may open a screen of the properties widget 506, the reservoir data widget 508, or additional widgets to provide additional information related to the solids 102 measured by the tomography system 52. For example, a digital representation of the reservoir may be presented by the reservoir data widget 508. The digital representation of the reservoir may be used to control the drilling operation by the drilling system 10, such as change an angle or direction of drilling (e.g., controlling a rotary steerable system (RSS) of a bottom hole assembly (BHA)), change a rotational speed of drilling (e.g., a drill bit of the BHA), change a flow of a mud fluid, stop drilling operations, and the like. Characteristics of the solids 102 may be utilized to provide subsurface characterization to geoscientists and reservoir engineers in the oil and gas industry in near-real time. As a result, an efficiency of the drilling operation by the drilling system 10 may be increased based on information extracted from the solids 102 produced during reservoir drilling.

Technical effects of the disclosed embodiments include a tomography system 52 for extracting physical properties of solids from transmission images taken in the context of oil and/or gas exploration. The tomography system 52 may include an imaging system 54 and an analysis system 60. The imaging system 54 may include one or more sources 106, one or more detectors 108, or a combination thereof, controlled by a controller 202 to acquire transmission images of one or more solids 102 in projectile motion 232, such solids 102 moving freely through the air separate from any structures. The projectile motion 232 combined with rotational motion 234 of the solids 102 may enable more complete 360 degree imaging of the solids 102 by the imaging system 54 with or without any movement (e.g., rotation) of the imaging system 54. In other words, rather than moving the sources 106 and detectors 108 of the imaging system 54, the projectile motion 232 combined with rotational motion 234 of the solids 102 causes substantially all sides or surfaces of the solids 102 to be exposed to and imaged by sets of the sources 106 and detectors 108. A tracking model may estimate one or more Gaussians to model the solids 102 in projectile motion 232. The tracking model may consider kinematic motion and/or dynamic motion of the Gaussians and optimize estimates to predict a location of the solids 102 in projectile motion 232. Transmission images of the solids 102 in projectile motion may be reconstructed to provide physical properties of the solids 102. The tomography system 52 may help streamline subsurface analysis through analysis of the solids 102 extracted during drilling as the solids 102 move from the conveyor 50 to the reserve pit 214. By streamlining solids analysis through incorporation of the tomography system 52 overall performance and efficiency of the drilling system 10 is improved through near real-time analysis of reservoir characteristics. The disclosed techniques result may result in reduced down time during drilling operations with less time spent analyzing solids off-site. Further, deployment of the presently disclosed techniques may provide improved efficiency and performance of drilling operations.

The subject matter described in detail above may be defined by one or more clauses, as set forth below.

A system is provided that an imaging system used to obtain images of one or more solids extracted from a reservoir during a projectile motion of the one or more solids, a processing circuitry, and a memory, accessible by the processing circuitry, the memory storing instructions that, when executed by the processing circuitry cause the processing circuitry to perform operations. The operations include controlling the imaging system to obtain the images of the one or more solids during the projectile motion and obtaining one or more physical properties of the one or more solids based on the images of the one or more solids during the projectile motion.

The system of the preceding clause, wherein the processing circuitry cause the processing circuitry to perform the operations including controlling the imaging system to obtain the images of the one or more solids during both the projectile motion and a rotational motion of the one or more solids.

The system of any of the preceding clauses, wherein the processing circuitry cause the processing circuitry to perform the operations including tracking the one or more solids during the projectile motion.

The system of any of the preceding clauses, wherein the processing circuitry cause the processing circuitry to perform the operations including generating one or more Gaussians to model each of the one or more solids in the projectile motion, performing an affine transformation of the one or more Gaussians with one or more unknown parameters, estimating the one or more unknown parameters based on rotational motion and/or directional motion, representing the one or more estimated unknown parameters with a forward model, generating a projection data set based on the forward model of the one or more estimated unknown parameters, and obtaining the one or more physical properties of the one or more solids based on the projection data set.

The system of any of the preceding clauses, wherein the processing circuitry cause the processing circuitry to perform the operations including optimizing the projection data set generated by the forward model based on a kinematic motion, a dynamic motion, or a combination thereof.

The system of any of the preceding clauses, wherein the processing circuitry cause the processing circuitry to perform the operations includes forming a digital representation of the reservoir based on the one or more physical properties of the one or more solids, and controlling a drilling system based on the digital representation of the reservoir.

The system of any of the preceding clauses, wherein the imaging system is configured to obtain the images of the one or more solids at a plurality of energy levels.

The system of any of the preceding clauses, wherein the imaging system includes one or more sources configured to irradiate the one or more solids in the projectile motion via an energy source and one or more detectors configured to acquire the images.

The system of any of the preceding clauses, wherein the energy source comprises an X-ray source, a neutron source, a gamma ray source, or a combination thereof.

The system of any of the preceding clauses, wherein the one or more sources and the one or more detectors are in a fixed position.

The system of any of the preceding clauses, wherein the one or more detectors is a detector array.

The system of any of the preceding clauses, wherein the images comprise one or more directional transmission attenuation scans based on one or more rays connecting the one or more sources to the one or more detectors.

The system of any of the preceding clauses, wherein the one or more physical properties comprise a porosity, a saturation, a permeability, a mineralogy, a lithology, a density, or a combination thereof.

The system of any of the preceding clauses, wherein the one or more solids in the projectile motion comprise one or more solids falling from a conveyor of a shale shaker to a reserve pit.

A method is provided that includes controlling, via processing circuitry, an imaging system to obtain images of one or more solids extracted from a reservoir during a projectile motion of the one or more solids and obtaining, via the processing circuitry, one or more physical properties of the one or more solids based on the images of the one or more solids during the projectile motion.

The method of the preceding clause, wherein the one or more physical properties comprise a porosity, a saturation, a permeability, a mineralogy, a lithology, a density, or a combination thereof.

The method of any of the preceding clauses, wherein controlling the imaging system to obtain images comprises controlling an energy source to obtain the images of the one or more solids at a plurality of energy levels, and the energy source comprises an X-ray source, a neutron source, a gamma ray source, or a combination thereof.

A non-transitory, computer-readable storage medium, is provided that includes processor-executable routines that, when executed by a processor, cause the processor to perform operations including controlling an imaging system to obtain images of one or more solids extracted from a reservoir during a projectile motion of the one or more solids and obtaining one or more physical properties of the one or more solids based on the images of the one or more solids during the projectile motion.

The non-transitory computer-readable storage medium of the preceding clause, wherein controlling the imaging system to obtain images comprises controlling an energy source to obtain the images of the one or more solids at a plurality of energy levels, wherein the energy source comprises an X-ray source, a neutron source, a gamma ray source, or a combination thereof, wherein the one or more physical properties comprise a porosity, a saturation, a permeability, a mineralogy, a lithology, a density, or a combination thereof.

The non-transitory computer-readable storage medium of any of the preceding clauses, including generating one or more Gaussians to model each of the one or more solids in the projectile motion, performing an affine transformation of the one or more Gaussians with one or more unknown parameters, estimating the one or more unknown parameters based on rotational motion and/or directional motion, representing the one or more estimated unknown parameters with a forward model, generating a projection data set based on the forward model of the one or more estimated unknown parameters, and obtaining the one or more physical properties of the one or more solids based on the projection data set.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A system, comprising:
an imaging system configured to obtain images of one or more solids extracted from a reservoir during a projectile motion of the one or more solids;
a processing circuitry; and
a memory, accessible by the processing circuitry, the memory storing instructions that, when executed by the processing circuitry cause the processing circuitry to perform operations comprising:
controlling the imaging system to obtain the images of the one or more solids during the projectile motion; and
obtaining one or more physical properties of the one or more solids based on the images of the one or more solids during the projectile motion.

2. The system of claim 1, wherein the processing circuitry cause the processing circuitry to perform the operations comprising:
controlling the imaging system to obtain the images of the one or more solids during both the projectile motion and a rotational motion of the one or more solids.

3. The system of claim 1, wherein the processing circuitry cause the processing circuitry to perform the operations comprising:
tracking the one or more solids during the projectile motion.

4. The system of claim 3, wherein the processing circuitry cause the processing circuitry to perform the operations comprising:
generating one or more Gaussians to model each of the one or more solids in the projectile motion;
performing an affine transformation of the one or more Gaussians with one or more unknown parameters;
estimating the one or more unknown parameters based on rotational motion and/or directional motion;
representing the one or more estimated unknown parameters with a forward model;
generating a projection data set based on the forward model of the one or more estimated unknown parameters; and
obtaining the one or more physical properties of the one or more solids based on the projection data set.

5. The system of claim 4, wherein the processing circuitry cause the processing circuitry to perform the operations comprising:
optimizing the projection data set generated by the forward model based on a kinematic motion, a dynamic motion, or a combination thereof.

6. The system of claim 1, wherein the processing circuitry cause the processing circuitry to perform the operations comprising:
forming a digital representation of the reservoir based on the one or more physical properties of the one or more solids; and
controlling a drilling system based on the digital representation of the reservoir.

7. The system of claim 1, wherein the imaging system is configured to obtain the images of the one or more solids at a plurality of energy levels.

8. The system of claim 1, wherein the imaging system comprises:
one or more sources configured to irradiate the one or more solids in the projectile motion via an energy source; and
one or more detectors configured to acquire the images.

9. The system of claim 8, wherein the energy source comprises an X-ray source, a neutron source, a gamma ray source, or a combination thereof.

10. The system of claim 8, wherein the one or more sources and the one or more detectors are in a fixed position.

11. The system of claim 8, wherein the one or more detectors is a detector array.

12. The system of claim 8, wherein the images comprise one or more directional transmission attenuation scans based on one or more rays connecting the one or more sources to the one or more detectors.

13. The system of claim 1, wherein the one or more physical properties comprise a porosity, a saturation, a permeability, a mineralogy, a lithology, a density, or a combination thereof.

14. The system of claim 1, wherein the one or more solids in the projectile motion comprise one or more solids falling from a conveyor of a shale shaker to a reserve pit.

15. A method comprising:
controlling, via processing circuitry, an imaging system to obtain images of one or more solids extracted from a reservoir during a projectile motion of the one or more solids; and
obtaining, via the processing circuitry, one or more physical properties of the one or more solids based on the images of the one or more solids during the projectile motion.

16. The method of claim 15, wherein the one or more physical properties comprise a porosity, a saturation, a permeability, a mineralogy, a lithology, a density, or a combination thereof.

17. The method of claim 15, wherein controlling the imaging system to obtain images comprises controlling an energy source to obtain the images of the one or more solids at a plurality of energy levels, and the energy source comprises an X-ray source, a neutron source, a gamma ray source, or a combination thereof.

18. A non-transitory, computer-readable storage medium, comprising processor-executable routines that, when executed by a processor, cause the processor to perform operations comprising:
controlling an imaging system to obtain images of one or more solids extracted from a reservoir during a projectile motion of the one or more solids; and
obtaining one or more physical properties of the one or more solids based on the images of the one or more solids during the projectile motion.

19. The non-transitory computer-readable storage medium of claim 18, wherein controlling the imaging system to obtain images comprises controlling an energy source to obtain the images of the one or more solids at a plurality of energy levels, wherein the energy source comprises an X-ray source, a neutron source, a gamma ray source, or a combination thereof, wherein the one or more physical properties comprise a porosity, a saturation, a permeability, a mineralogy, a lithology, a density, or a combination thereof.

20. The non-transitory computer-readable storage medium of claim 18, comprising:
generating one or more Gaussians to model each of the one or more solids in the projectile motion;
performing an affine transformation of the one or more Gaussians with one or more unknown parameters;
estimating the one or more unknown parameters based on rotational motion and/or directional motion;
representing the one or more estimated unknown parameters with a forward model;
generating a projection data set based on the forward model of the one or more estimated unknown parameters; and
obtaining the one or more physical properties of the one or more solids based on the projection data set.
